(19) United States
(12) Patent Application Publication
(10) Pub. No.: US 2002/0188951 A1
(43) Pub. Date: Dec. 12, 2002

(54) Data active on-demand-transmission system

(75) Inventors: Sung-Yao Chang, TaoYuan (TW); Ching-Feng Wang, TaiNan (TW)

Correspondence Address: DOUGHERTY & TROXELL, 5205 LEESBURG PIKE, SUITE 1404, FALLS CHURCH, VA, 22041, US

(73) Assignee: TelePaq Technology Inc.

(21) Appl. No.: 09/874,126

(22) Filed: Jun. 6, 2001

(51) Int. Cl. H04N 7/173; G06F 15/16

(52) U.S. Cl. 725/93; 725/100; 725/87; 709/219

(57) ABSTRACT

The convention transmission method is an on-demand data communication, in which one discloses a demand and one provides a supply. However, this communication way is not suitable nowadays. Since amount of current data transmission is very large. In order to improve the quality in service, the service provider provides actively the required service to the customer. After browsing by the customer, then the customer transfers the selection items to the service provider and then the service provider provides required service to the customers, By this way, the customer may browse products rapidly and the quality of information service is improved.

### FIELD OF THE INVENTION

The present invention relates to a data active on-demand-transmission system, wherein by communication transmission technology, the data catalogue of the service provider is actively transferred to a personal digital assistant for being browsed and selected by the personal digital assistant.

### BACKGROUND OF THE INVENTION

With the progress of technology, under the combination of customer' electronic products and communication technology, the speeds of data transmission, for example broadcasts, televisions, telephones, and others are quicker and quicker, so that the human life is varied quickly by both wireless or wired communication. Of course, this improvement is necessary and beneficial. This has a greater effect to commerce.

In a communication transmission, there is a supply end and a demand end so as to be connected and then be formed as an integrated structure. FIG. 1 is a block schematic view showing in the conventional technology for transferring a data signal, the demand and supply ends are represented by a plurality of customer ends 10, 14. Each of the customer ends 10, 14 may be a demand end or a supply end demand on the input or output. A servo and a plurality of base stations 11, 13 are includes in the plurality of customer ends. The data from the customers are processed and transferred through the servos 12 and the plurality of base station 11 and 13 so as to achieve the object of communication.

The abovesaid is a simplest process in communication. However, this is a passive service which is not satisfied by the consumers. Although, the customer's end 10 and 14 can be replaced by service providers, but it is also confined in a supply way of supplying for a demanding request. In order to provide an optimum service quality, a better system service module is necessary.

### SUMMARY OF THE INVENTION

Accordingly, the primary object of the present invention is to provide a data active on-demand-transmission system for solving the defects in the prior art. In the present invention, the service required by the customer is provided to the customers without interfering customers. The customer need not disclose a request for acquiring a service catalogue.

Another object of the present invention is to provide a data active on-demand-transmission system, in the aforesaid prior art, a plurality of customer ends transfer data through servos and base stations. The plurality of customers may be a servo of the system service provider. By the servos and base stations to transfer data, the required service is provided to the connected customer end. In the present invention, in the flow process for each component of the data catalogue between the serve and customer end is controlled so that the servo may actively provides required service to the customers Thus, the customers may select conveniently.

Preferably, a system servo between the servo and the receiving end serves to receive all data from the servo, after arrangement and integration, a proper data catalogue is formed. Then, a proper designed transmission interface transfers the data catalogue to the customer receiving end for being browsing by the customer.

Preferably, in the data processing of the data active on-demand-transmission system of the present invention, after receiving a data, then the data is arranged and integrated, it is transferred through a transmission interface, and then is browsed by the customer.

Preferably, after the customer receives the data catalogue, the service provider provides product catalogue and then is displayed on a screen. Then, the customer instructs a selection command, the order data is transferred and acknowledge operation is performed.

Preferably, by using a broadcast technology and a one-to-many transmission protocol, data catalogue is actively transferred to an objected receiving end. Therefore, the resource of bandwidth consumed in bidirectional transmission is saved. Furthermore, in an active transmission, by an on-demand transmission protocol, a optimum integration and adjustment are performed between the demand end and the supply end.

Preferably, in the present invention, by Internet to transfer data catalogue, or by a personal digital assistant to receive the data catalogue from wireless transmission, the customers can select service items. Moreover, by the wireless application protocol (WAP), the data active on-demand-transmission system of the present invention can be achieved.

The various objects and advantages of the present invention will be more readily understood from the following detailed description when read in conjunction with the appended drawing.

### BRIEF DESCRIPTION OF THE DRAWINGS

FIG. 1 is a block schematic view of a communication transmission in one embodiment of the present invention.

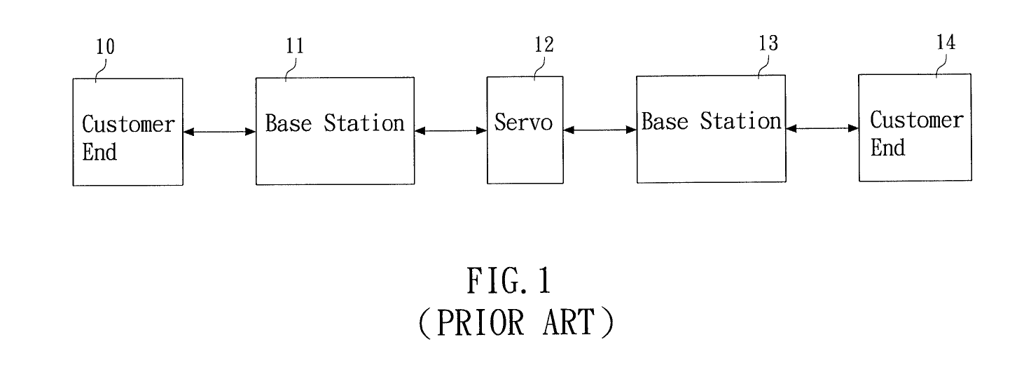

FIG. 2 is a front schematic view for the application of personal digital assistant in the present invention,

FIG. 3 is a block schematic view for the communication transmission in the embodiment of the present invention.

FIG. 4 is a schematic view about the data processing in the embodiment of the present invention

FIG. 5 is a flow diagram showing an acknowledge of order in the embodiment of the present invention.

### DETAILED DESCRIPTION OF THE PREFERRED EMBODIMENT

In the data active on-demand-transmission system of the present invention, a proper receiving servo, such as personal digital assistant (PDA), displays a catalogue data. Then, the selected service item is transferred back to the service, provider for performing proper work. When providing catalogue data, the customer is unnecessary to inform network system service provider about the required data. These data is directly provided by the network service provider for improving the quality of service and the time consumed by the customer is reduced.

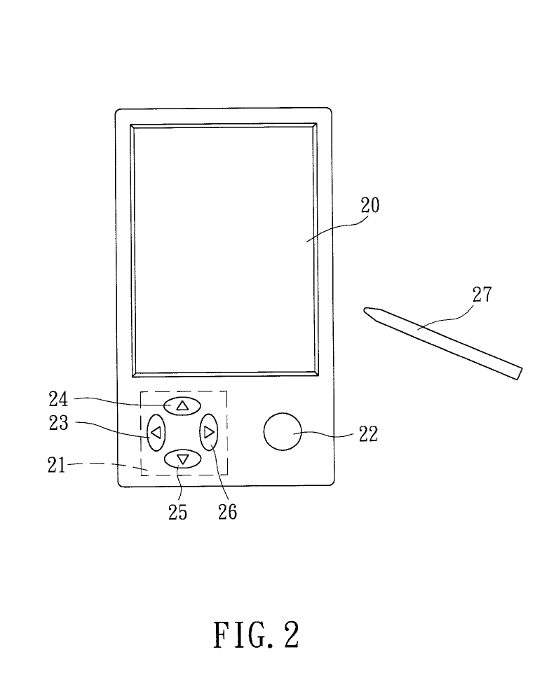

Since the present invention is about a processing system in the communication transmission, in practical application, it needs to use a wireless or wired consumer's electronic devices, such as mobile phones, pagers, Internet, and others. In the embodiment of the present invention, a multiple-functional personal digital assistant is used. With reference to FIG. 2, a personal digital assistant is employed in this embodiment. It is appreciated that the personal digital assistant includes a display screen 20 which displays the data catalogue. A direction selection unit 21 and an input key 22 are formed below the display screen 20. The direction selection unit 21 is installed with a left key 23, a right key 26, an up key 25, a down key 25. The keys 23, 24, 25 and 26 serve to control the movement of cursor. As the selection work is accomplished, the input key 22 serves to select working item. The personal digital assistant further includes a sensor pen 27. By directly touching the items on the display screen 20, a respective work is performed.

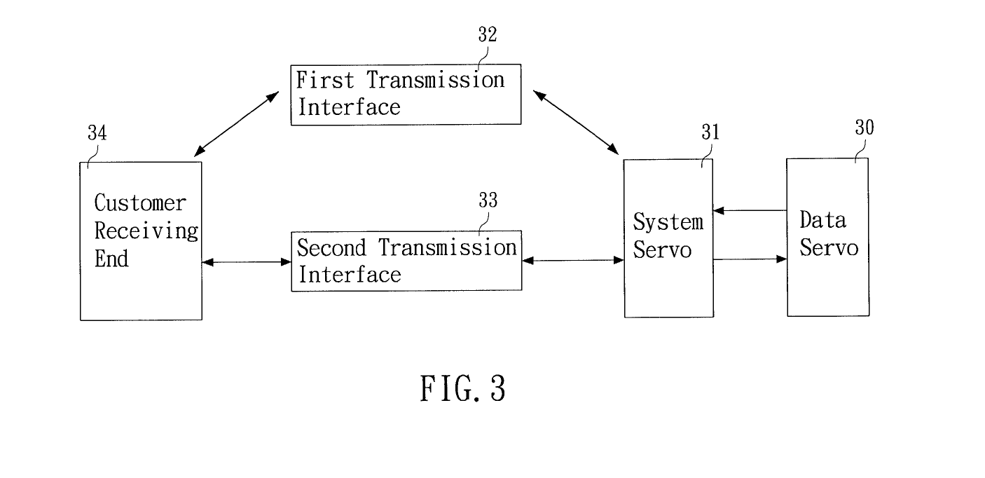

Referring to FIG. 3, a block schematic view for one embodiment of the present invention is illustrated. It is appreciated that in the communication transmission, all the data catalogue is provided by the data servo end 30, and a system servo serves to integrate the data. A first transmission interface 32 serve to play the data. The customer receiving end 34 is used to receive and display the data catalogue. In the customer receiving end 34, a personal digital assistant 20 in FIG. 2 is employed to receive and display the data catalogue.

In FIG. 3, a signal transmission is performed between the system servo 31 and customer receiving end 34. The system servo 31 receives and integrates the catalogue data from the data servo 30. By a proper transmission interface, the catalogue data is actively transmitted to the personal digital assistant of the customer receiving end 34. The transmission interface has a first transmission interface 32 and a second transmission interface 33. The system servo 31 receives the catalogue data from the data servo. The data catalogue is transferred by a proper transmission interface. The first transmission interface 32 has a one-to-many transmission mode. By an active transmission, the signals are transferred to many customers 34. The second transmission interface 33 performs a one-to-one transmission by a system setting in the customer receiving end 34. By the data transmission mode in the second transmission interface, the transmission data is kept secret.

The catalogue data transferred by the first transmission interface 32 is selected and confirmed. Then, the signal is output through the signal transmitting unit in the personal digital assistant of the customer receiving end 34 to inform the system servo 31 to analyze the signal and proper processing work is returned back to the data servo 30. Therefore, in performing a work, the system servo 31 performs a proper data processing by the frequent communication between the data servos. It actively and continuously transfers data catalogue to the customer receiving end 34 by the second transmission interface. In the customer receiving end 34, the selected data item is transferred back to the system servo 31. The selected data catalogue is transferred back to the system servo 31. The selected data item are transferred directly to the system servo 31, and the signal transmission is unnecessary to pass through the first transmission interface.

Referring to FIGS. 2 and 3, the personal digital assistant used in the customer receiving end can be connected to an I/O port of a computer through a signal transmission line. After setting a communication protocol, the data is transferred through a communication module of Internet. As the signal is transferred, an application specific integrated circuit (ASIC) is installed in the personal digital assistant. This application specific integrated circuit outputs proper selecting items for providing a one to one acknowledge operation.

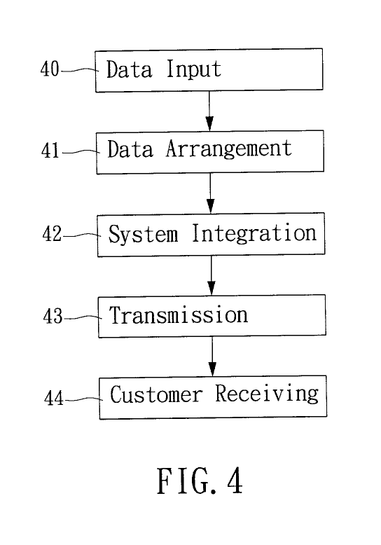

Referring to FIG. 4, a schematic view of the data processing in the embodiment of the present invention is illustrated. The system servo outputs all data to the system servo. The system servo performs the following operation for transferring data catalogue to the customer receiving end;

1. Date input: the data servo output catalogue data, and the system servo serves to input data.

2. Data arrangement: the catalogue data is put in order and classified for expanding the catalogue contents of the data catalogue.

3. System integration: an stacking work for transmission data is performed and then the data is transferred to the transmission interface.

4. Transmission: The data is transferred through a transmission channel.

5. The customer receives the signal.

In the step of data processing, the system servo classifies the catalogue data and by a trellis classify structure, the system construction is arranged in order, As the data is transferred and played, by wired and wireless transmission technology, the data transmission is performed,

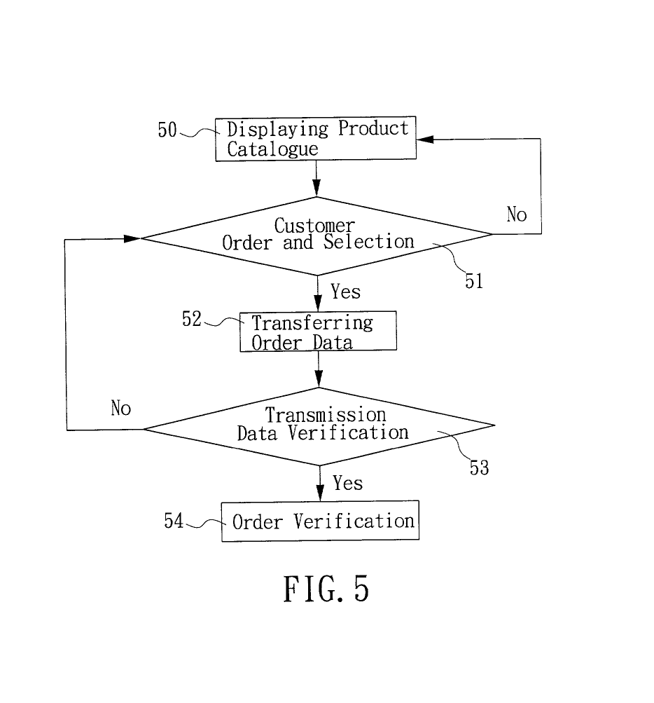

Referring to FIG. 5, a flow diagram for assuring an order in the embodiment of the present invention is illustrated. The customer receiving end receives the data catalogue actively transferred from the transmission interface, then the acknowledgement of an order is processed by following step:

1. Display product catalogue, the display screen of the personal digital assistant of the customer receiving end displays the data catalogue processed by the system servo.

2. The order selection: a selection operation is performed through a selection way provided by the personal digital assistant. If the selection work is not performed, the system servo actively transfers data catalogue by a proper transmission interface.

3. Transmission of ordering data: after the customer accomplishes the selection operation for ordering, then the proper signal output is performed by a personal digital assistant.

4. Verification operation: the system servo verifies the transferred order data. If the data is wrong, then the customer selection operation is re-performed.

5. Order verification: assure that the order is correct, and the overall operation is complete.

In the order acknowledge step illustrated in FIG. 5, a special series number in the application specific integrated circuit (ASIC) in the personal digital assistant is used to provide an acknowledge number at the order acknowledge work.

The present invention is thus described, it will be obvious that the same may be varied in many ways. In practical application, the present invention is not confined to be accomplished by a personal digital assistant. Since the progressive of the current communication technology, the transmission mode of the present invention can be used in the transmission of the computer Internet or wireless application protocol (WAP) in the mobile phones, or general pagers, cable TVs. The system service provider can provide the information and service required by the customers to the customers. Such variations are not to be regarded as a departure from the spirit and scope of the present invention, and all such modifications as would be obvious to one skilled in the art are intended to be included within the scope of the following claims.

What is claimed is:

1. A data active on-demand-transmission system, a personal digital assistant receiving required catalogue data, the catalogue data being provided by a data servo; or being integrates by a system servo, then data is transferred by a proper transmission interface; the data catalogue being received and displayed by a personal digital assistant at the customer receiving end; characteristic in that:
the system servo receives and integrates the catalogue data from the system servo, then the transmission interface transfers catalogue data to the customer receiving end; the customer receiving end receiving the catalogue data actively transferred from the transmission interface; after the catalogue is selected and assured by the customer, then the selection is transferred back to the system servo from the personal digital assistant to inform the system servo to analysis and process the signal, further, processed data is transferred to the data servo.

2. The data active on-demand-transmission system as claimed in claim 1, wherein in the customer receiving end, a personal digital assistant is employed to receive the data catalogue; and the customer's selection is outputted; wherein the personal digital assistant includes:
a display screen displaying data catalogue
a direction selection unit having a left key, a right key, an up key, and a down key for controlling a movement of a cursor;.
an input key for selection of items;
a sensor pen; by directly touching the items on the display screen a respective operation is performed.

3. The data active on-demand-transmission system as claimed in claim 1 or 2, wherein the personal digital assistant of the customer receiving end is connected to an input/output port of a network through a cable, the data is transferred through communication module of Internet.

4. The data active on-demand-transmission system as claimed in claim 1, wherein an application specific integrated circuit (ASIC) is formed within the personal digital assistant; this application specific integrated circuit provides an one-to-one acknowledge signal for the selection item.

5. The data active on-demand-transmission system as claimed in claim 1, wherein the data servo outputs a catalogue data to the system servo, the system servo accomplishes the transmission to the customer receiving end by the steps of:
date input: the data servo outputting catalogue data, and the system servo serving to input data;
data arrangement: the catalogue data being put in order and classified for expanding the catalogue contents of the data catalogue;
system integration: an stacking work for transmission data being performed and then the data being transferred to the transmission interface;
transmission: the data being transferred through a transmission channel; and
a customer receiving the data.

6. The data active on-demand-transmission system as claimed in claim 1, wherein In the step of data arrangement, the system servo classifying the catalogue data and by a trellis classifying structure, the system construction being arranged in order.

7. The data active on-demand-transmission system as claimed in claim 1, wherein in the step of system integration, a communication system serves to perform a transmission operation.

8. The data active on-demand-transmission system as claimed in claim 1 or 5, wherein after the customer receiving end receives a catalogue data transferred actively from the transmission interface, the verification of an order is accomplished by following step of:
displaying product catalogue: the display screen of the personal digital assistant of the customer receiving end displays the data catalogue processed by the system servo;
order selection: a selection operation being performed through a selection way provided by the personal digital assistant; if the selection work being not be performed, the system servo actively transfers data catalogue by a proper transmission interface;
transmission of ordering data: after the customer accomplishes the selection operation for ordering, then the signal being outputted to a personal digital assistant;
verification operation: the system servo verifies the transferred order data, if the data is wrong, then the order selection operation being performed again;
order verification: assure that the order being correct, and the overall operation being complete.

9. The data active on-demand-transmission system as claimed in claim 8, wherein in the acknowledge step, for the transmission of order data, a series number contained in an application specific integrated circuit within the personal digital assistant is used as an verification signal for the verification step.

10. A data active on-demand-transmission system, a wireless personal digital assistant serving to receive a data catalogue from the system servo; the data catalogue being displayed by the wireless personal digital assistant; then a selection operation being performed, and a correspondent signal being transferred back to the system servo; characteristic in that:
transmission of the data catalogue from the system servo is actively transferred through a transmission interface; a selection operation is performed in the customer receiving end; and then an operation correspondent to the selection is performed.

11. The data active on-demand-transmission system as claimed in claim 10, wherein the data catalogue of the system servo is provided by a system servo, the system servo performs a required data processing.

12. The data active on-demand-transmission system as claimed in claim 10, wherein the personal digital assistant includes a display screen, a direction selection unit, an input key, a sensing pen, wherein the direction selection key and the input key control a movement of a cursor on the screen for selection required object.

13. The data active on-demand-transmission system as claimed in claim 12, wherein the personal digital assistant selects an object by the sensing pen to move on the display screen.

14. The data active on-demand-transmission system as claimed in claim 12, wherein an application specific integrated circuit (ASIC) is formed within the personal digital assistant; this application specific integrated circuit provides a one-to-one verification signal for the selection item.

15. The data active on-demand-transmission system as claimed in claim 10, wherein the system servo accomplishes the transmission to the customer receiving end by the steps of:
date input: the system servo serving to input data;
data arrangement: the catalogue data being put in order and classified and a trellis file structure being used to classify the data;
system integration: an stacking work for transmission data being performed and then the data being transferred to the transmission interface;
transmission: the data being transferred through a transmission channel; and
a customer receiving the data.

16. The data active on-demand-transmission system as claimed in claim 1, wherein the customer receiving end performs an work of verification to an order by the following step:
displaying product catalogue: the display screen of the personal digital assistant of the customer receiving end displays the data catalogue processed by the system servo;
order selection: a selection operation being performed through a selection way provided by the personal digital assistant; if the selection work being not be performed, the system servo actively transferring the data catalogue by a transmission interface;
transmission of ordering data: after the customer accomplishes the selection operation for ordering, then the signal being outputted to a personal digital assistant; further, an application specific integrated circuit being installed in an application specific integrated circuit in the personal digital assistant; and the application specific integrated circuit serving to couple signals as the customer selection is outputted;
verification operation: the system servo verifies the transferred order data, if the data is wrong, then the order selection operation being performed again;
order verification: assuring that the order being correct, and the overall operation being complete.
